(19) United States
(12) Patent Application Publication
(10) Pub. No.: US 2008/0222120 A1
(43) Pub. Date: Sep. 11, 2008

(54) System and method for video recommendation based on video frame features

(76) Inventors: Nikolaos Georgis, San Diego, CA (US); Paul Jin Hwang, Burbank, CA (US); Frank Li-De Lin, Escondido, CA (US)

Correspondence Address: ROGITZ & ASSOCIATES, 750 B STREET, SUITE 3120, SAN DIEGO, CA, 92101, US

(21) Appl. No.: 11/715,803

(22) Filed: Mar. 8, 2007

(51) Int. Cl. G06F 17/30

(52) U.S. Cl. 707/4

(57) ABSTRACT

Video recommendations are generated based on video features such as motion vectors, color saturation, and scene changes.

### FIELD OF THE INVENTION

The present invention relates generally to systems and methods for content recommendation.

### BACKGROUND OF THE INVENTION

Systems and methods have been developed to recommend content to users of home entertainment systems based on similarities between user preferences and metadata indications of what is in content that might be a candidate for a match. Thus, a user might indicate explicitly or implicitly that he prefers films starring a particular person, and a recommendation engine might search for and return films whose metadata (typically, non-displayed text contained at the beginning of a video stream) indicate that the preferred person stars in the films.

As understood herein, more than just non-displayed metadata can be used to recommend video content such as films to users, and specifically display features of a video can provide useful signals as to whether the video should or should not be recommended for viewing by a particular user.

### SUMMARY OF THE INVENTION

A method is disclosed for recommending video content that includes processing respective sequences of video frames from plural candidate video streams. The method further includes extracting non-metadata video features from the sequences, and based on the video features, returning at least one of the candidate video streams as a recommendation.

The video features may include, without limitation, scene changes, color saturation, motion vectors, etc.

In one non-limiting implementation a subset of the video features is selected, and only the subset is used to return at least one of the candidate video streams as a recommendation. A training set of features may be used as part of the subset selection. If desired, non-metadata video features from the sequences may be used in combination with metadata and/or audio features to return candidate video streams as a recommendation.

In another aspect, a system includes a source of candidate videos and a computer receiving the candidate videos and executing logic that includes extracting video features from the videos, and using the video features and information related to a user's video preferences, providing a recommendation to the user of at least one of the candidate videos.

In yet another aspect, a computer readable medium bears computer-executable instructions that are embodied as means for extracting non-metadata, non-audio features from plural candidate video units, and means for processing the non-metadata, non-audio features from plural candidate video units to generate at least one recommended video unit that matches a user's preferences.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with the present invention; and

FIG. 2 is a flow chart of one non-limiting implementation of the present logic.

### DETAILED DESCRIPTION OF THE PREFERRED EMBODIMENT

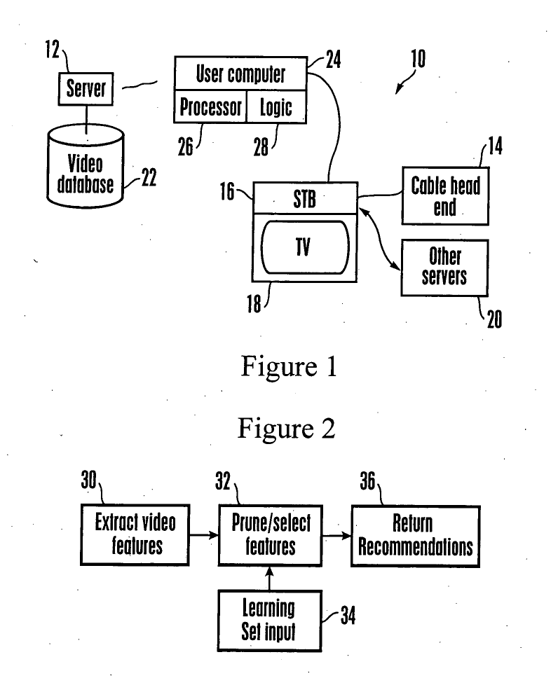

Referring initially to FIG. 1, a system is shown, generally designated 10, that includes a video content provider server 12 such as but not limited to an Internet server. The system 10 may also include alternate sources of video content such as a cable head end server 14 communicating with a user's TV 16 through, e.g., a set-top box 18, and video content may also be provided directly to an Internet-enabled TV from other Internet servers 20 through a browser in the TV.

Focusing on the Internet server 12, the server 12 may access a video database 22 containing movies, TV shows, or other video. The server 12 may communicate with a computer such as a user computer 24 that can be co-located with and communicate with the TV 16 as shown, and the computer 24 may include a processor 26 executing a logic module 28 stored on a computer-readable medium (such as, e.g., solid state memory, disk memory, etc.) to undertake the logic herein. It is to be understood, however, the present logic may be executed at the server 12, the head end server 14, the other servers 20, or it can be distributed among the various computers shown herein.

Now referring to FIG. 2, for each of a plurality of candidate video streams from, e.g., the servers 12/20 and/or head end server 14, video features are extracted from at least some of the frames. Thus, being video features of the frames, the extracted features are not metadata, although as described below metadata may be used on conjunction with the video features to return recommendations.

Without limitation, the video features that can be extracted from the frames include scene changes which indicate whether the video is fast-changing or slow-changing. The video features can also include color saturation which indicate certain genre such as cartoons, which have high color saturation. The video features can further include motion vectors which also indicate whether a movie is action-packed or not. Other non-limiting video features that can be used include luminance and chrominance (which itself can be used as an indicator of scene changes). In non-limiting implementations statistical reasoning models can be used to detect events such as scene changes.

Moving to block 32, the set of video features is pruned in that a subset of features is selected in accordance with a learning set input at block 34. In one implementation, the learning set is global. In other implementations, the learning set is personal to the user for whom the recommendations are being made.

In greater detail, in a first implementation the learning set is based on how well each extracted video feature is able to return a “good” recommendation as evaluated by many “training” users. For example, the video preferences of each training user may be gleaned either by direct querying and input of each user (e.g., by asking the user what her favorite movie and movie genre is, etc.) or by observing user purchases of movies and her viewing habits. Then, the video features of the video preferences can be matched against respective features collected from several training candidate video streams, with a candidate stream being returned as a recommendation if one of its features approximates (within a threshold range) the corresponding feature of the video preferences. For instance, if videos with high color saturation are preferred in the training set, a candidate stream is returned as a recommendation if its color saturation is also high.

Each user is then asked to grade the recommended candidate as either a “good” or “poor” recommendation, with those video features resulting in cumulative grades of “poor” (or at least not having on average grades of “good”) being pruned at block 32, leaving only those video features that happen to produce “good” recommendations” as evaluated in the training set at block 34.

In a second implementation, the above process is tailored to each individual user, i.e., each user defines her own video preferences to establish a training set and the pruning at block 32 thus is different for each user. In either case, neural network adaptive training principles can be used to determine which extracted video features to use, and in the case of detecting spatial and temporal similarities between the video features of the user preferences and those of the training set (e.g., when motion vectors are the video feature under consideration), fractal methods can be used. Discrete Cosine Transform (DCT), wavelets, Gabor analysis, and model-based methods may also be used.

Once the “best” of the extracted video features have been selected at block 32, recommendations of video streams are returned at block 36. The recommendations are made based on matching, in accordance with the principles set forth above, the “best” of the extracted video features against corresponding features from each user (either input explicitly by each user or as inferred from observing user channel selections/movie orders) to whom a recommendation is being made.

If desired, the video features alone may be used to generate recommendations as described, or they may be combined with other recommendation criteria such as metadata and audio features to provide a composite recommendation. In the latter case, each criterion may be assigned its own empirically-determined weight, again derived using a learning set in accordance with present principles. For instance, video feature matches between a candidate video stream and the user's corresponding preferences may be assigned a higher weight than metadata matches between a candidate video stream and the user's corresponding preferences. The weighted criteria can then be added together, and the candidate video stream with the highest weight (or the top “N” weighted streams) may be returned as recommendations. Audio feature extraction can be accomplished in accordance with audio feature extraction principles known in the art.

The recommendations may be returned to the user any number of ways, e.g., by sending them to and displaying them on the TV 16 or the user computer 24, etc.

While the particular SYSTEM AND METHOD FOR VIDEO RECOMMENDATION BASED ON VIDEO FRAME FEATURES is herein shown and described in detail, it is to be understood that the subject matter which is encompassed by the present invention is limited only by the claims.

What is claimed is:

1. A method for recommending video content, comprising:
processing respective sequences of video frames from plural candidate vide streams;
extracting non-metadata video features from the sequences; and
based at least in part on at least some of the video features, returning at least one of the candidate video streams as a recommendation.

2. The method of claim 1, wherein the video features include scene changes.

3. The method of claim 1, wherein the video features include color saturation.

4. The method of claim 1, wherein the video features include motion vectors.

5. The method of claim 1, further comprising selecting a subset of the video features, only the subset being used to return at least one of the candidate video streams as a recommendation.

6. The method of claim 5, wherein a training set of features is used as part of the selecting act.

7. The method of claim 1, comprising using both non-metadata video features from the sequences and at least one criterion selected from the group of: metadata, or audio features, to return at least one of the candidate video streams as a recommendation.

8. A system comprising:
at least one source of candidate videos; and
at least one computer receiving the candidate videos and executing logic comprising:
extracting video features from the videos; and
using the video features and information related to a user's video preferences, providing a recommendation to the user of at least one of the candidate videos.

9. The system of claim 8, wherein the video features include scene changes.

10. The system of claim 8, wherein the video features include color saturation.

11. The system of claim 8, wherein the video features include motion vectors.

12. The system of claim 8, wherein the computer selects a subset of the video features, only the subset being used to return at least one of the candidate videos as a recommendation.

13. The system of claim 12, wherein the computer uses a training set of features as part of selecting a subset of features.

14. The system of claim 8, wherein the computer uses both non-metadata video features from the sequences and at least one criterion selected from the group of: metadata, or audio features, to return at least one of the candidate videos as a recommendation.

15. A computer readable medium bearing computer-executable instructions embodied as:
means for extracting non-metadata, non-audio features from plural candidate video units; and
means for processing the non-metadata, non-audio features from plural candidate video units to generate at least one recommended video unit that matches a user's preferences.

16. The medium of claim 15, wherein the non-metadata, non-audio features include motion vectors.

17. The medium of claim 15, wherein the non-metadata, non-audio features include color saturation.

18. The medium of claim 15, wherein the non-metadata, non-audio features include scene changes.

19. The medium of claim 15, further comprising means for selecting a subset of the video features, only the subset being used to return a recommendation.

20. The medium of claim 15, comprising means for using both the non-metadata, non-audio features and at least one criterion selected from the group of: metadata, or audio features, to return at least one of the candidate video units as a recommendation.
